(19) United States
(12) Patent Application Publication
(10) Pub. No.: US 2009/0313488 A1
(43) Pub. Date: Dec. 17, 2009

(54) ELECTRONIC APPARATUS SERVING AS USB HOST AND USB DEVICE

(75) Inventor: Yong-Der LEE, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei (TW)

(21) Appl. No.: 12/485,465

(22) Filed: Jun. 16, 2009

(30) Foreign Application Priority Data
Jun. 15, 2008 (TW) 097126835

(51) Int. Cl. G06F 1/00

(52) U.S. Cl. 713/300

(57) ABSTRACT

An electronic apparatus includes a host controller, a device receptacle, a multiplexer, an outside voltage detecting and controlling circuit, an interface converting unit, and a storage unit. The host controller includes a first data terminal and a first power voltage output terminal for outputting a first power voltage. The device receptacle includes a second data terminal and a second power voltage output terminal. The multiplexer has two input terminals respectively connected with the first data terminal and the second data terminal. If a second power voltage is issued from the second power voltage output terminal of the device receptacle to the outside voltage detecting and controlling circuit, the third power voltage output terminal of the outside voltage detecting and controlling circuit issues the second power voltage, and the output terminal of the multiplexer is connected with the second data terminal.

### FIELD OF THE INVENTION

The present invention relates to an electronic apparatus, and more particularly to an electronic apparatus serving as a USB host and a USB device.

### BACKGROUND OF THE INVENTION

A universal serial bus (USB) is a serial bus standard to connect devices to a host computer. Many computer peripherals such as printers, scanners or storage units are allowed to be connected with the host computer via USB interfaces so as to perform data transmission.

According to USB specifications, electronic apparatuses with USB interfaces can be classified into two types, i.e. USB hosts and USB devices. Generally, a USB host has a host controller. When a USB device is connected with the USB host, the host controller of the USB host could provide a source voltage of +5V to the USB device. The host controller could issue a control command to the USB device in order to control operations of the USB device. Generally, a personal computer and a notebook computer could be referred as a USB host. When the USB device is connected with the USB host, the source voltage of +5V provided by the USB host is used by the USB device and thus the USB device executes a corresponding task according to the control command.

FIG. 1A is a schematic view illustrating a host receptacle of the USB host according to the prior art. The host receptacle is also referred as a type-A receptacle, which is the most common receptacle. The type-A receptacle is usually mounted in a desktop computer or a notebook computer. As shown in FIG. 1A, the standard type-A receptacle has four pins, including a voltage providing pin Vcc_P, a ground pin GND, and two differential data pins D+ and D−. In addition to the standard type-A receptacle, the type-A receptacle further includes a mini type-A receptacle and a micro type-A receptacle.

FIG. 1B is a schematic view illustrating a device receptacle of the USB device according to the prior art. The device receptacle is also referred as a type-B receptacle. As shown in FIG. 1B, the standard type-B receptacle has four pins, including a voltage receiving pin Vcc_R, a ground pin GND, and two differential data pins D+ and D−. In addition to the standard type-B receptacle, the type-B receptacle further includes a mini type-B receptacle and a micro type-B receptacle.

Generally, a cable is used for connecting a USB host and a USB device. Both terminals of the cable have USB plugs. The USB host and the USB device have a host receptacle and a device receptacle, respectively. The USB plug is usually classified into a type-A plug and a type-B plug. The type-A plug could only be inserted into the type-A receptacle. The type-B plug could only be inserted into the type-B receptacle. For connecting the USB host having the type-A plug and the USB device having the type-B receptacle, the cable should have type-A plug at a first terminal and a type-B plug at a second terminal.

FIG. 2 is a schematic circuit block diagram of a network media player according to the prior art. As shown in FIG. 2, the network media player 100 comprises a network receptacle 112, an AV terminal 114, a processing unit 110, a host controller 120, an interface converting unit 130 and a storage unit 140. The processing unit 110 is connected with the network receptacle 112 (e.g. a RJ45 receptacle). Via the network receptacle 112, the processing unit 110 could link to the internet. The processing unit 110 is used to process video data. The processed video data are transmitted to the external display unit (not shown) through the AV terminal 114 in order to play the video data. For storing the video data, the network media player 100 further includes a storage unit 140. An example of the storage unit 140 includes a SATA (serial advanced technology attachment) hard disk or a PATA (parallel advanced technology attachment) hard disk.

Take a SATA hard disk for example. The host controller 120 and the interface converting unit 130 are arranged between the processing unit 110 and the storage unit 140. The host controller 120 has a first USB port 122 connected with the interface converting unit 130. That is, the voltage providing pin, the ground pin and the two differential data pins of the first USB port 122 are connected with the interface converting unit 130. The interface converting unit 130 is connected with the storage unit 140 for converting the USB-format access command and USB-format access data into a SATA-format access command and a SATA-format access data, respectively.

For reading the data stored in the storage unit 140, the processing unit 110 of the network media player 100 issues a read command to the host controller 120. The read command is converted into a USB-format read command by the host controller 120, and the USB-format read command is then transmitted to the interface converting unit 130. The USB-format read command is converted into a SATA-format access command by the interface converting unit 130, and the SATA-format access command is then transmitted to the storage unit 140. When the SATA-format access command is received by the storage unit 140, the read data corresponding to the read command are transmitted to the interface converting unit 130. The read data are converted into the USB-format read data by the interface converting unit 130, and then the USB-format read data are transmitted to the host controller 120. The USB-format read data are then transmitted to the processing unit 110. For writing data into the storage unit 140 of the network media player 100, the similar converting procedures are performed and are not redundantly described herein.

The host controller 120 has a second USB port 124 connected with a host receptacle 116. Via the host receptacle 116, the network media player 100 could be communicated with an USB device (e.g. an external storage unit), so that the host controller 120 is accessible to the USB device. In other words, the network media player 100 could be considered as a USB host.

Through the internet connection, the network media player 100 could be communicated with a remote media server and receive the video data from the media server. After the video data from the media server are received by the processing unit 110, the video data are processed by the processing unit 110 and the processed video data are displayed on the external display unit. By the user's control, the video data from the media server could be stored in the storage unit 140. The video data or files stored in the storage unit 140 could be processed by the processing unit 110, and the processed video data could be displayed on the external display unit.

The network media player 100 is a USB host. A USB device (e.g. an external storage unit) could be inserted into the host receptacle 116 of the network media player 100. As such, the video data or files stored in the USB device could be transferred to the processing unit 110 through the host controller 120. After the video data from the USB device are received by the processing unit 110, the video data are processed by the processing unit 110, and the processed video data are displayed on the external display unit or stored in the storage unit 140.

Generally, a USB apparatus is defined as either a USB host or a USB device. No USB apparatus could act as both of a USB host and a USB device. The above network media player 100 only acts as a USB host.

### SUMMARY OF THE INVENTION

The present invention relates to an electronic apparatus capable of serving as a USB host and/or a USB device, so that the electronic apparatus has both functions of a USB host and a USB device.

In accordance with an aspect of the present invention, there is providing an electronic apparatus serving as a host and a device. The electronic apparatus includes a host controller, a device receptacle, a multiplexer, an outside voltage detecting and controlling circuit, an interface converting unit, and a storage unit. The host controller includes a first data terminal and a first power voltage output terminal for outputting a first power voltage. The device receptacle includes a second data terminal and a second power voltage output terminal. The multiplexer has a first input terminal connected with the first data terminal and a second input terminal connected with the second data terminal. The outside voltage detecting and controlling circuit is connected with the first power voltage output terminal and the second power voltage output terminal for generating a select signal to a select terminal of the multiplexer. The outside voltage detecting and controlling circuit has a third power voltage output terminal. The interface converting unit is connected with an output terminal of the multiplexer and the third power voltage output terminal. The storage unit is connected with the interface converting unit. If a second power voltage is issued from the second power voltage output terminal of the device receptacle to the outside voltage detecting and controlling circuit, the third power voltage output terminal of the outside voltage detecting and controlling circuit issues the second power voltage, and the output terminal of the multiplexer is connected with the second data terminal.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic view illustrating a host receptacle of the USB host according to the prior art;

FIG. 1B is a schematic view illustrating a device receptacle of the USB device according to the prior art;

FIG. 2 is a schematic circuit block diagram of a network media player according to the prior art;

FIG. 3 is a schematic circuit block diagram of a network media player according to an embodiment of the present invention; and

FIG. 4 is a schematic diagram illustrating the outside voltage detecting and controlling circuit used in the network media player of the present invention.

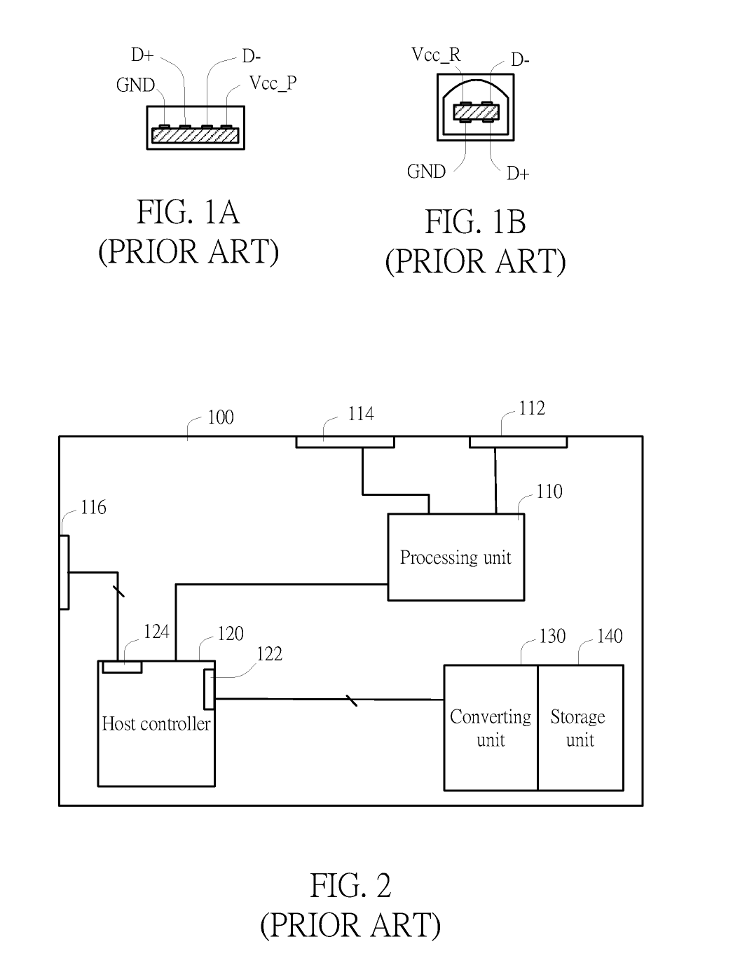

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

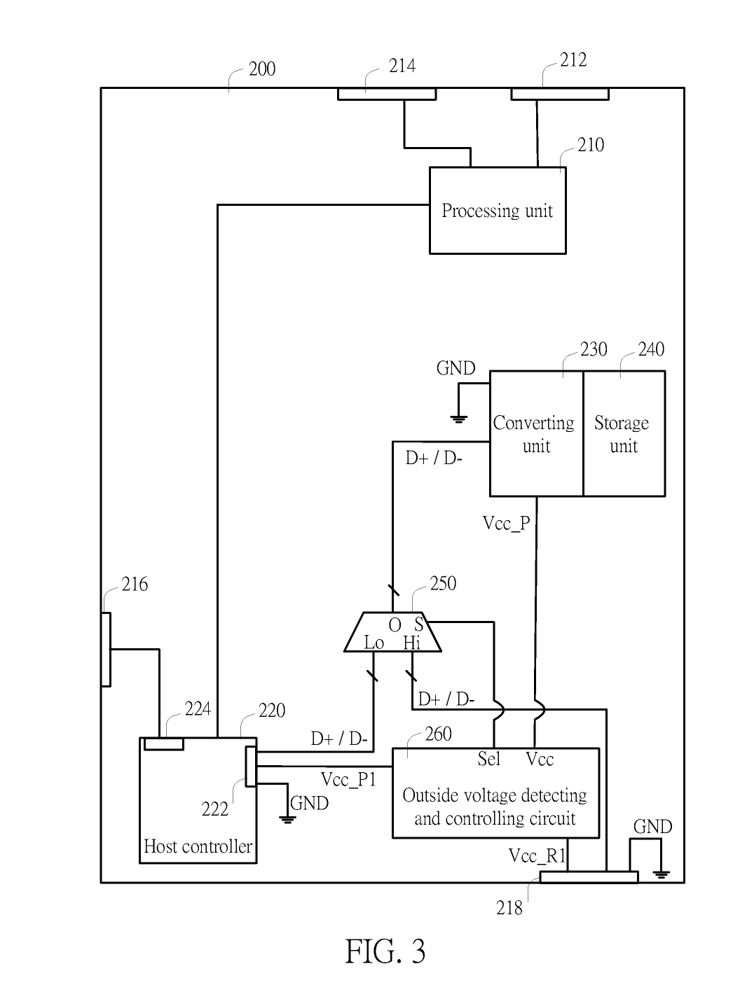

FIG. 3 is a schematic circuit block diagram illustrating a network media player according to an embodiment of the present invention. As shown in FIG. 3, the network media player 200 comprises a network receptacle 212, an AV terminal 214, a host receptacle 216, a processing unit 210, a host controller 220, an interface converting unit 230, a storage unit 240, a multiplexer 250, an outside voltage detecting and controlling circuit 260, and a device receptacle 218.

The processing unit 210 is connected with the network receptacle 212 (e.g. a RJ45 receptacle). Via the network receptacle 212, the processing unit 110 could link to the internet. The processing unit 210 is used to process video data. The processed video data are transmitted to the external display unit (not shown) through the AV terminal 214 in order to play the video data. The processing unit 210 is also connected with the processing unit 210. The host controller 220 has a second USB port 124 connected with the host receptacle 216. Via the host receptacle 216, the network media player 200 could be communicated with an USB device (e.g. an external storage unit), so that the host controller 220 is accessible to the USB device. Under this circumstance, the network media player 200 could be considered as a USB host.

The host controller 220 has a first USB port 222. The two differential data pins D+ and D− of the first USB port 222 are connected with a first input terminal Lo of the multiplexer 250. The two differential data pins D+ and D− of the device receptacle 218 are connected with a second input terminal Hi of the multiplexer 250. The output terminal of the multiplexer 250 is connected with the two differential data pins D+ and D− of the interface converting unit 230.

The voltage providing pin Vcc_P1 of the host controller 220 and the voltage receiving pin Vcc_R1 of the device receptacle 218 are connected with the outside voltage detecting and controlling circuit 260. In a case that the device receptacle 218 is not connected with an external USB host, no voltage signal is received by the voltage receiving pin Vcc_R1 of the device receptacle 218. Meanwhile, the select terminal Sel of the outside voltage detecting and controlling circuit 260 issues a low-level select signal (Lo) to the multiplexer 250. In response to the low-level select signal, the two differential data pins D+ and D− of the first USB port 222 are connected with the output terminal of the multiplexer 250. In addition, the power voltage offered by the voltage providing pin Vcc_P1 of the first USB port 222 will be transmitted to the interface converting unit 230 through the outside voltage detecting and controlling circuit 260. Under this circumstance, the storage unit 240 is controlled by the host controller 220 of the network media player 200.

In anther case that an external USB host is inserted into the device receptacle 218, a power voltage offered by the external USB host is transmitted to the voltage receiving pin Vcc_R1 of the device receptacle 218. Meanwhile, the select terminal Sel of the outside voltage detecting and controlling circuit 260 issues a high-level select signal (Hi) to the multiplexer 250. In response to the high-level select signal, the two differential data pins D+ and D− of the device receptacle 218 are connected with the output terminal of the multiplexer 250. At the same time, the outside voltage detecting and controlling circuit 260 will isolate the power voltage that is offered by the voltage providing pin Vcc_P1 of the first USB port 222. In addition, the power voltage received by the voltage receiving pin Vcc_R1 of the device receptacle 218 will be transmitted to the interface converting unit 230 through the outside voltage detecting and controlling circuit 260. The power voltage received by the voltage receiving pin Vcc_R1 of the device receptacle 218 is sufficient to operate the storage unit 240. Under this circumstance, the storage unit 240 is controlled by the external USB host, and the network media player 200 could be considered as a USB device.

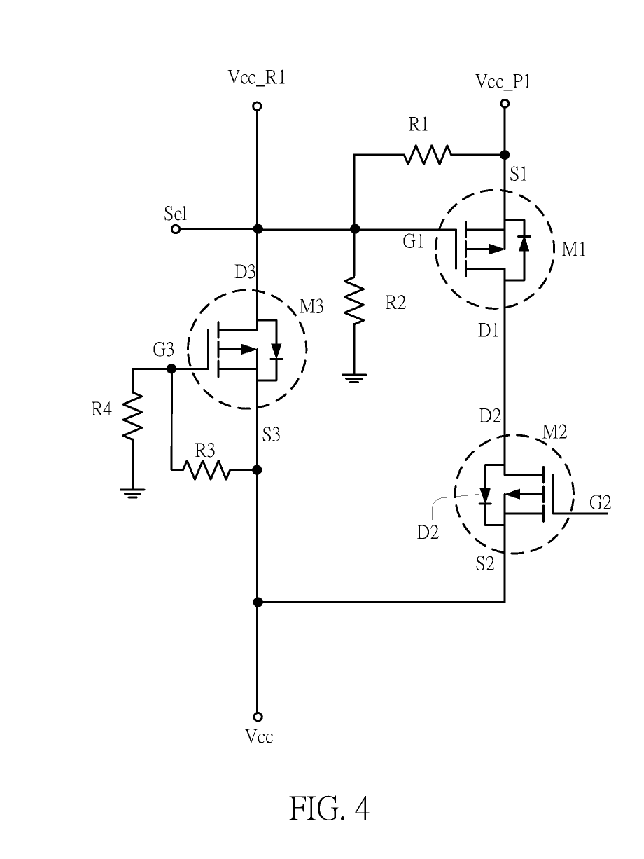

FIG. 4 is a schematic diagram illustrating the outside voltage detecting and controlling circuit used in the network media player of the present invention. As shown in FIG. 4, the outside voltage detecting and controlling circuit comprises three PMOS transistors M1, M2 and M3, and four resistors R1, R2, R3 and R4. The voltage providing pin Vcc_P1 of the first USB port 222 is connected with the source electrode S1 of the first PMOS transistor M1. The gate electrode G1 of the first PMOS transistor M1 is connected with the voltage receiving pin Vcc_R1 of the device receptacle 218 and the select terminal Sel. The first resistor R1 is interconnected between the source electrode S1 and the gate electrode G1 of the first PMOS transistor M1. The second resistor R2 is interconnected between the gate electrode G1 of the first PMOS transistor M1 and the ground terminal.

The drain electrode D2 of the second PMOS transistor M2 is connected with the drain electrode D1 of the first PMOS transistor M1. The source electrode S2 of the second PMOS transistor M2 is connected with a power voltage output terminal Vcc. The gate electrode of the second PMOS transistor M2 is opened. The drain electrode D3 of the third PMOS transistor M3 is connected with the gate electrode G1 of the first PMOS transistor M1. The source electrode S3 of the third PMOS transistor M3 is connected with the power voltage output terminal Vcc. The third resistor R3 is interconnected between the source electrode S3 and the gate electrode G3 of the third PMOS transistor M3. The fourth resistor R4 is interconnected between the gate electrode G3 of the third PMOS transistor M3 and the ground terminal. Since the second PMOS transistor M2 only utilizes the body diode D2 between the drain electrode D2 and the source electrode S2, the second PMOS transistor M2 can be replaced by a diode. In an embodiment, R1=100 KΩ, R2=10 KΩ, R3=10 KΩ, R4=100 KΩ, and the threshold voltage Vt of each of the three PMOS transistors M1, M2 and M3 is −1V.

In a case that no external USB host is inserted into the device receptacle 218 of the network media player 200, the voltage providing pin Vcc_P1 of the first USB port 222 offers a power voltage of +5V. As such, the voltage value at the source electrode S1 of the first PMOS transistor M1 is 5V (V_{S1}=5V), and the voltage value at the gate electrode G1 of the first PMOS transistor M1 is 0.45V (V_{G1}=0.45V). That is, the voltage difference between the gate electrode G1 and the source electrode S1 of the first PMOS transistor M1 is −4.55V (V_{G1S1}=−4.55V). Since −4.55V is smaller than the threshold voltage Vt of the first PMOS transistor M1 (Vt=−1V), the first PMOS transistor M1 is turned on. The power voltage +5V offered by the voltage providing pin Vcc_P1 of the first USB port 222 will be transmitted to the power voltage output terminal Vcc through the body diode D2 of the second PMOS transistor M2. Moreover, the voltage value at the select terminal Sel is equal to the voltage value at the gate electrode G1 of the first PMOS transistor M1 (V_{G1}=Vₛₑₗ=0.45V). As a result, a low-level select signal (Lo) is outputted from the select terminal Sel.

In a case that an external USB host is inserted into the device receptacle 218 of the network media player 200, the voltage receiving pin Vcc_R1 of the device receptacle 218 offers a power voltage of +5V. As such, the voltage value at the source electrode S1 of the first PMOS transistor M1 is 5V (V_{S1}=5V), and the voltage value at the gate electrode G1 of the first PMOS transistor M1 is 5V (V_{G1} =5V). That is, the voltage difference between the gate electrode G1 and the source electrode S1 of the first PMOS transistor M1 is 0V (V_{G1S1} =0V). Since 0V is greater than the threshold voltage Vt of the first PMOS transistor M1 (Vt=−1V), the first PMOS transistor M1 is turned off. Meanwhile, the power voltage (+5V) offered by the voltage providing pin Vcc_P1 of the first USB port 222 fails to be transmitted to the power voltage output terminal Vcc.

The voltage value at the drain electrode D3 of the third PMOS transistor M3 is 5V (V_{D3}=5V). The voltage value at the gate electrode G3 of the third PMOS transistor M3 (V_{G3}=0V). That is, the voltage difference between the gate electrode G3 and the drain electrode D3 of the third PMOS transistor M3 is −5V (V_{G3D3}=−5V). Since −5V is greater than the threshold voltage Vt of the third PMOS transistor M3 (Vt=−1V), the third PMOS transistor M3 is turned on. The power voltage +5V offered by the voltage providing pin Vcc_P1 of the first USB port 222 will be transmitted to the power voltage output terminal Vcc. Moreover, the voltage value at the select terminal Sel is equal to the voltage value at the gate electrode G1 of the first PMOS transistor M1 (V_{G1}=Vₛₑₗ=5V). As a result, a high-level select signal (Hi) is outputted from the select terminal Sel. Due to the body diode D2 of the second PMOS transistor M2, the power voltage (+5V) offered by the voltage receiving pin Vcc_R1 of the device receptacle 218 is obstructed from being transmitted to the voltage providing pin Vcc_P1.

From the above description, the network media player of the present invention can be selectively used as a USB host or USB device. If an external USB host is inserted into the device receptacle of the network media player 200, the external USB host can control accessing operations of the storage unit of the network media player. Even when the network media player is powered off, the external USB host can offer power voltage to the storage unit. Whereas, if an external USB device is connected with the host receptacle of the network media player, the network media player can control operations of the external USB device so as to exchange between the external USB device and the storage unit.

In the above embodiments, the present invention is illustrated by referring to a network media player. Nevertheless, the concept of the present invention can be applied to any electronic apparatus capable of serving as a USB host or USB device.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic apparatus serving as a host and a device, the electronic apparatus comprising:
a host controller comprising a first data terminal and a first power voltage output terminal for outputting a first power voltage;
a device receptacle comprising a second data terminal and a second power voltage output terminal;
a multiplexer having a first input terminal connected with the first data terminal and a second input terminal connected with the second data terminal;
an outside voltage detecting and controlling circuit connected with the first power voltage output terminal and the second power voltage output terminal for generating a select signal to a select terminal of the multiplexer, wherein the outside voltage detecting and controlling circuit has a third power voltage output terminal;
an interface converting unit connected with an output terminal of the multiplexer and the third power voltage output terminal; and
a storage unit connected with the interface converting unit,
wherein if a second power voltage is issued from the second power voltage output terminal of the device receptacle to the outside voltage detecting and controlling circuit, the third power voltage output terminal of the outside voltage detecting and controlling circuit issues the second power voltage, and the output terminal of the multiplexer is connected with the second data terminal.

2. The electronic apparatus according to claim 1 wherein if no second power voltage is issued from the second power voltage output terminal of the device receptacle to the outside voltage detecting and controlling circuit, the third power voltage output terminal of the outside voltage detecting and controlling circuit issues the first power voltage, and the output terminal of the multiplexer is connected with the first input terminal.

3. The electronic apparatus according to claim 1 wherein the host controller further comprises a first port and a second port, the first port comprises the first data terminal and the first power voltage output terminal, and the second port includes a third data terminal and a fourth power voltage output terminal.

4. The electronic apparatus according to claim 3 wherein the electronic apparatus further comprises a host receptacle connected with the second port of the host controller, and the host receptacle is connectable with an external device.

5. The electronic apparatus according to claim 4 wherein the host receptacle is a USB host receptacle including a voltage providing pin, a ground pin and two differential data pins, and the USB host receptacle is connectable with an external USB device.

6. The electronic apparatus according to claim 3 wherein the first port and the second port of the host controller are USB ports, each of which including a voltage providing pin, a ground pin and two differential data pins.

7. The electronic apparatus according to claim 1 wherein the device receptacle is a USB device receptacle including a voltage receiving pin, a ground pin and two differential data pins, and the USB device receptacle is connectable with an external USB host.

8. The electronic apparatus according to claim 1 wherein the storage unit is a hard disk.

9. The electronic apparatus according to claim 8 wherein the interface converting unit allows USB-format data to be converted into data readable by the hard disk, or allows the data stored in the hard disk to be converted into USB-format data.

10. The electronic apparatus according to claim 1 wherein the outside voltage detecting and controlling circuit comprises:
a first PMOS transistor having a source electrode connected with the first power voltage output terminal and a gate electrode connected with the second power voltage output terminal;
a first resistor interconnected between the source electrode and the gate electrode of the first PMOS transistor;
a second resistor interconnected between the gate electrode of the first PMOS transistor and a ground terminal;
a diode having an anode connected with a drain electrode of the first PMOS transistor and a cathode connected with the third power voltage output terminal;
a third PMOS transistor having a source electrode connected with the third power voltage output terminal and a drain electrode connected with the second power voltage output terminal;
a third resistor interconnected between the source electrode and a gate electrode of the third PMOS transistor; and
a fourth resistor interconnected between the gate electrode of the third PMOS transistor and a ground terminal,
wherein the select signal is outputted from the gate electrode of the first PMOS transistor.

11. The electronic apparatus according to claim 10 wherein the diode is a body diode of a second PMOS transistor.
